(19) United States
(12) Patent Application Publication
(10) Pub. No.: US 2005/0145113 A1
(43) Pub. Date: Jul. 7, 2005

(54) Method and installation for preparing lettuce heads

(76) Inventor: Laurent Savary, Angoville Sur Ay (FR)

Correspondence Address: BAKER & DANIELS;111 E. WAYNE STREET, SUITE 800, FORT WAYNE, IN, 46802, US

(21) Appl. No.: 11/020,709

(22) Filed: Dec. 23, 2004

(30) Foreign Application Priority Data
Dec. 30, 2003 (FR) 03 15 562

(51) Int. Cl. A01D 45/02

(52) U.S. Cl. 99/485

(57) ABSTRACT

Method of preparing lettuce heads with means for removing the stalk from the head prior to cutting it.

A visible, luminous reference line (2) is generated in the zone where the item (P) is placed on a positioning support (41), this line defining the orientation of the item. The item is then positioned on the (41) and anchored and the item (P), thus positioned, is conveyed until it makes contact with a hooking means (ET) so that the item (P) can be automatically picked up with a view to conveying it in readiness for removing the stalk.

### FIELD OF THE INVENTION

The present invention relates to a method and an installation for preparing lettuce heads with means for removing the stalk from the head before cutting it. In general terms, the invention applies to items such as lettuce heads or vegetables of this type, from which it is necessary to remove the stalk from the useful part before processing it, in particular cutting.

### PRIOR ART

The idea of removing stalks from lettuce heads before cutting them is already known. These operations are performed virtually automatically in an installation into which the lettuce heads are introduced. This installation has conveyor means fitted with hooks, which are anchored in the lettuce head on a level with the stalk. The head is then fed through a stalk-removing station, in which the stalk part is cut so that it can be separated from the useful part. Although this installation is practical, it nevertheless has a disadvantage insofar as the item or <<lettuce head>> has to be manually introduced, in which case it must be placed with the tail directed upwards and placed against a conveyor element with an inclined axis, the hooks of which are open. Once the lettuce head has been introduced, the hooks close around the stalk in order to hold the head and transport it alongside the blade which cuts off the stalk.

Another disadvantage of this installation is that it is not able to continue automatic processing of the useful parts of the items once the stalk has been removed.

### OBJECTIVE OF THE INVENTION

The objective of the present invention is to improve an installation of the type outlined above and a method that will facilitate positioning of the item from which the stalk has to be removed, in particular a lettuce head, and that will also enable the useful part of the item to be picked up so that it can continue to be automatically processed, whilst improving the work safety conditions at the time the item is introduced into the installation.

### DESCRIPTION AND ADVANTAGES OF THE INVENTION

To this end, the invention relates to a method of preparing items and in particular lettuce heads or similar vegetables from which the stalk has to be removed, characterised in that a visible, luminous reference line is generated in the zone where the item is placed on a positioning support, which line defines the orientation of the item, after which the item is placed on the support and anchored, and thus positioned, the item is conveyed with the support until it comes into contact with the hooking device so that the item can be automatically picked up and hooked to convey it with a view to removing the stalk.

The invention also relates to an installation for preparing items from which the stalk has to be removed, in particular lettuce heads, of the type defined above, characterised in that it comprises
a station at which the items (lettuce heads) are positioned in a given orientation,
a hooking station which picks up the items positioned at the positioning station to convey them in a suspended position and
a stalk-removing station in which the stalk is removed from the item in the suspended position,
a set of support modules, each having a support for receiving and holding the items and conveying them, these modules circulating on a positioning route passing through the positioning station,
a set of transfer elements equipped with hooking elements which are anchored in the item on a level with the stalk, these transfer elements circulating on a transfer route which rejoins the positioning route and passes through the hooking station and stalk-removing station,
   the positioning station having a generator which generates a luminous reference line in a defined position relative to the support module as it arrives at the positioning station so as to define the position in which the item must be placed relative to the receiving support,
   the hooking station receiving the oriented items, borne by the support of the support modules,
   the stalk-removing station having a cutting device equipped with a blade which successively receives the transfer elements in order to remove the stalks from the items, so that the cut stalk remains hooked on the transfer elements.

In accordance with the invention, therefore, the items from which the stalks have to be removed are positioned in an extremely simple manner and without any risk to the operator. The latter uses the visibly illuminated reference line generated above the receiving support to set the item in an upturned position with the tail, i.e. the stalk part, turned upwards and disposed in alignment with the reference line. Since this reference line is a light beam, it can be interrupted by the item but will remain materialised in space. This significantly facilitates the task of positioning the item and obtaining the correct orientation of the top part of the item by sight. The reference line is preferably vertical, so that it is enough to lower the item to be placed on the support naturally rather than having to place it at a given inclination as is the case with the known installation. The gesture is a natural one and thus much easier, more precise and less tiring. Furthermore, the operator is not at risk of injuring himself on the claws of a hooking element, which are necessarily long and curved to gain a firm purchase in the material of the item on a level with the stalk.

Positioning the item on the spikes of the support does not pose any risk because these spikes are relatively short, their sole purpose being to retain the item as it is conveyed and not when the stalk is cut, apart from which they are also disposed on the side opposite the stalk.

This positioning is made even easier because the support module comprises a body with a receiving support fitted with spikes on which an item is pinned in order to position it, this support being displaceable in vertical translation relative to the body, controlled by an actuator depending on the position of the module along its route,
in order to position the item in the positioning station in the bottom position and
in order to guide the item underneath a transfer element into the hooking station in the top position.

Since the spikes are disposed vertically relative to the support surface, i.e. parallel with the reference line, the operator positions the item above the spikes of the receiving support and orients it correctly. In a simple lowering movement, he then pins the bottom of the item thus upturned on the spikes. They maintain the position of the item as it is transported alongside the hooking elements of the transfer element. Consequently, not only is the item correctly positioned, it remains so during all the operations prior to and during removal of the stalk, thus ensuring that the stalk is removed at the correct point, i.e. around the stalk.

By virtue of another advantageous feature, the beam generator positions its beam constituting the luminous reference line on the support module as it arrives at the positioning station and follows it whilst the item is being positioned.

The fact that the reference line is preserved during positioning of the item not only means that there is sufficient time to set the item in the receiving support but also to check that it is correctly oriented during all this time.

Incorrect orientation to any significant degree would effectively lead to incorrect stalk removal, i.e. only part of the stalk, cutting away the useful part of the item, which would mean having to reject the useful part.

As a result of another advantageous feature, the transfer element has hooks which are activated in order to anchor themselves in the stalk of the item, leaving the contour free as it passes the stalk-removing blade.

By virtue of another advantageous characteristic, the stalk-removing station comprises
a cutting device equipped with a blade, the device being fixed and the blade being displaceable between a retracted position and a cutting position sunk in the item from which the stalk has to be removed,
a device for driving the transfer element in rotation in the cutting position.

The installation proposed by the invention is advantageously completed by a cutting station downstream of the stalk-removing station, this station being equipped with a blade for separating the item from which the stalk has been removed into several parts and a set of cutting modules circulating on a cutting route passing through the stalk-removing station and crossing paths with the transfer route so that each one anchors itself in an item hooked on a transfer element and is fed with it into the stalk-removing device, which cuts the stalk hooked on the transfer element so as to separate the useful part of the item, which remains fixed to its cutting module, ready to be conveyed through the cutting station.

The transfer to the cutting station is operated automatically, as is the cutting operation.

Taking advantage of the fact that the item is correctly oriented in the transfer element, it is of advantage if the item is immediately placed in contact with the cutting module even before the stalk is removed from the item. This will ensure that the item resumes the correct orientation ready for use in the subsequent operation, in particular cutting, because this also has to be performed precisely relative to the shape of the item or more exactly the useful part of the item from which the stalk was previously removed. Cutting may be in halves or in quarters. The pieces thus obtained may be supplied in this format to the retailers or divided into smaller pieces in readiness for processing in the form of batches of pre-washed and trimmed salads.

The cutting module advantageously has a body accommodating
a cutting support displaceable in translation between a lowered position and a raised position,
a needle borne by the support, displaceable between an extracted position in which it is anchored in the item and a retracted position,
a first and a second jack controlling respectively the displacement of the support relative to the body and that of the needle.

Accordingly, the blade at the cutting station is in a fixed position and the useful part of the item borne by the cutting module is displaced relative to the blade, for example raised, especially as the cutting module already has the means needed to effect this movement.

Although the cutting module has a needle in a central or slightly offset position to enable the blade of the cutting station to move into a central position in one advantageous embodiment, this position does not have to be adhered to as strictly as industrial precision would dictate, given that the shape of the item, i.e. the lettuce head itself, may vary; the cutting precision to obtain halves, quarters or others must be precise but may suffer from the slight offset between the needle and the blade, which must necessarily pass alongside the needle.

It is also possible to use a displaceable cutter, in which case it will be lowered vertically to cut the lettuce anchored by the needle.

It is also possible to provide more than one needle, for example to provide two needles disposed in a symmetrical position relative to the reference line along which the item was positioned, in which case the blade may then pass through the space between the two needles. Retraction of the needles after cutting will release the parts of the cut item.

### DRAWINGS

The present invention will be described in more detail below with reference to an embodiment illustrated in the appended drawings, of which:

FIG. 1 is a view in the form of a block diagram illustrating an installation proposed by the invention,

FIG. 1A is a simplified side view of an embodiment of part of the installation proposed by the invention,

FIGS. 2A, 2B show different parts of the installation proposed by the invention in a more detailed illustration,

FIG. 3 is a view in section of the positioning module,

FIG. 4 is a view in section of the cutting module.

### DESCRIPTION OF AN EMBODIMENT

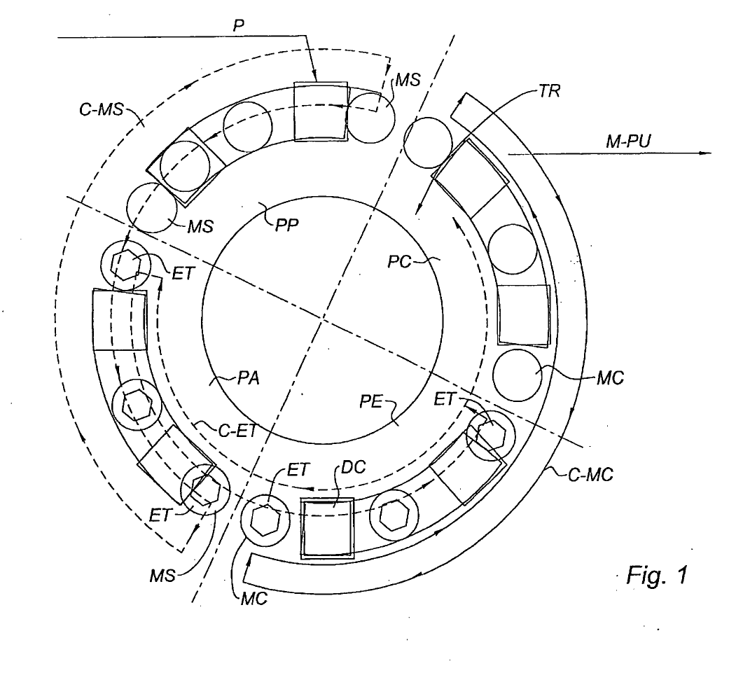

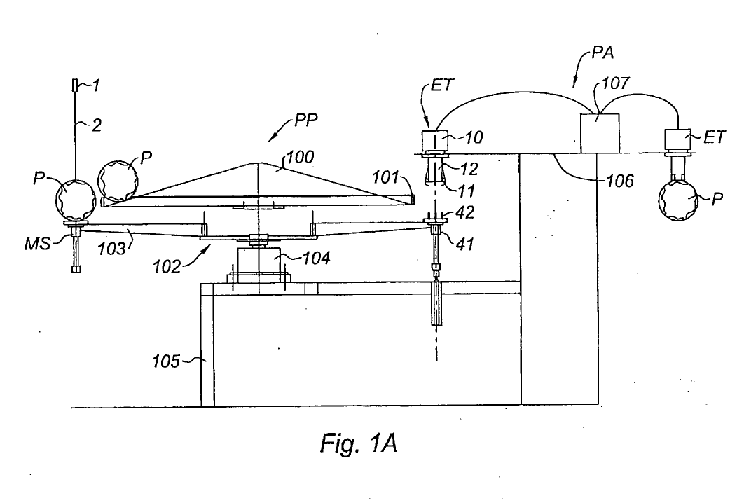

As illustrated in FIG. 1, an embodiment of an installation for preparing lettuce heads or products of this type, referred to as items P throughout the description below, by removing the stalks, has circulation and conveyor means mounted on a rotating drum TR or one of the conveyor chains passing through different stations, for example. At the inlet, the installation has a positioning station PP in which an operator positions the items to be processed P in a specific orientation. The items P are thus positioned on support modules MS, ready to be transported to a hooking station PA. Here, the items P are picked up from the support modules MS by transfer elements ET equipped with hooking elements, which anchor themselves in the item P on a level with the stalk T. The item is transferred, in the resultant suspended, vertical position, by the transfer element ET into a stalk-removing station PE equipped with a cutting device DC which cuts the stalk off each item. The stalk is evacuated and the useful part of the item is recovered.

In one improvement to this installation, downstream of the stalk-removing station PE, a cutting station PC is provided and cutting modules MC are fixed to the item P even before its stalk is removed so as to reposition it in its correct orientation. Once the stalk has been removed, the cutting module MC evacuates the useful part so that it can be conveyed to the cutting station PC, whilst the transfer element ET retains the stalk and evacuates it before returning to the inlet of the hooking station PA. The useful part PU is then cut in a precise manner at the cutting station PC and the pieces M-PU are evacuated for processing or packaging.

FIG. 1 illustrates the different positioning C-MS, transfer C-ET and cutting routes C-MC respectively followed by the support modules MS, transfer elements ET and cutting modules MC. The positioning route C-MS starts at the entrance to the positioning station PP and ends on leaving the hooking station PA. The transfer route C-ET taken by the transfer elements ET starts on entering the hooking station PA and passes through the stalk-removal station PE before subsequently entering the hooking station PA again. The route C-MC taken by the cutting modules starts at the stalk-removal station PE, passing through it as well as the cutting station PC, which it then leaves to return to the entrance of the stalk-removal station PE.

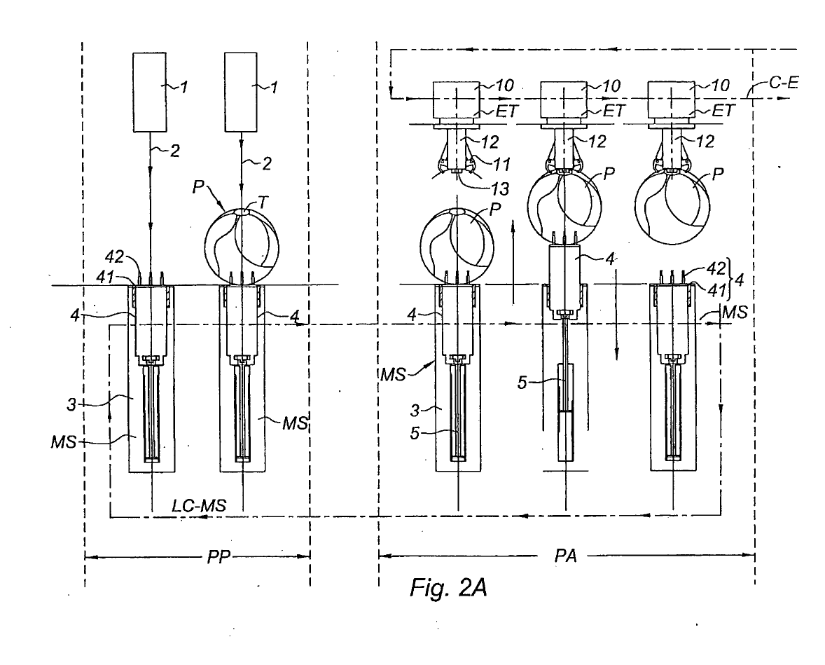

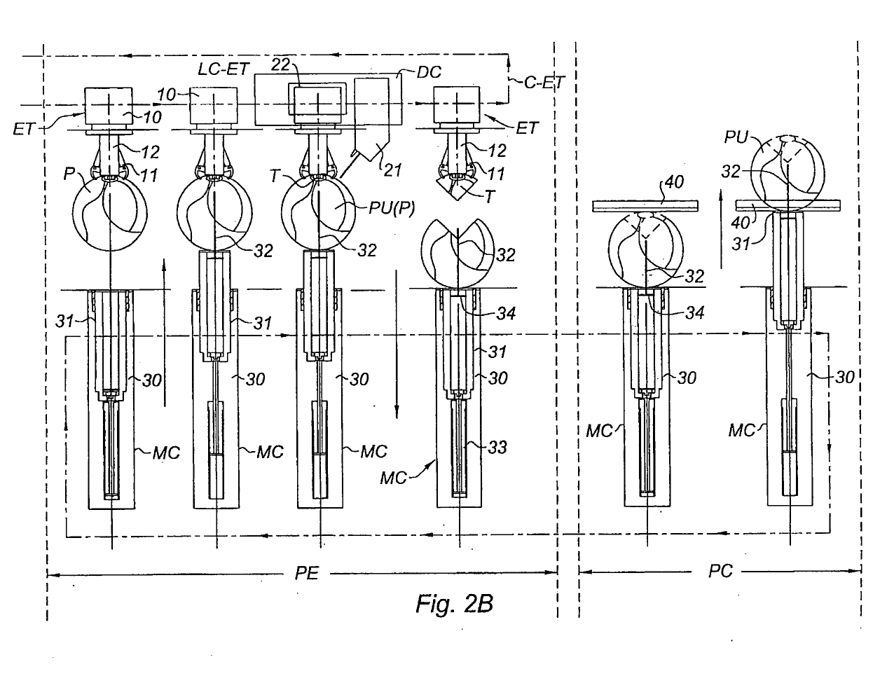

FIG. 1A is a schematic side view showing a part of the installation. The preparation station PP has an arrival area 100 in the shape of a truncated cone with an outer edge 101 for receiving the products P, represented by spheres. Tipped onto the cone 100, these products are retained by the edge 101, whilst being readily accessible. The installation also has the beam generator 1, such as a laser, which generates the positioning beam 2. The support modules MS on which the products P are positioned and oriented are of a design which will be explained below with reference to FIGS. 2A, 2B. These modules are borne by a rotor 102 equipped with radial arms 103, the unit as a whole being driven in rotation by a synchronised motor 104, supported by a frame 105.

FIG. 1A also shows the hooking station PA incorporating the transfer elements ET, which have an actuator 10 bearing hooks 11 by means of a jack 12. This hooking station also has a rotor 106 driven in rotation by a motor 107, which is synchronised with the general motion of the installation.

The various operations will be described in more detail with reference to the diagrams given in FIGS. 2A, 2B.

These diagrams show, respectively and in order, the positioning station PP followed by the hooking station PA, then the stalk-removing station PE and the cutting station PC.

The positioning station PP for the items P has a generator 1 generating a light beam 2 defining a luminous reference line (of visible light), for example a very low-power laser beam operating in visible red or green light. This reference line 2 is oriented in a precise manner and is so specifically in the vertical direction. It is fixed but may also be displaced in the positioning station PP, for reasons which will be explained later.

The generator 1 is installed directly at the indicated point or has an optical means for displacing the reference line, such as a displaceable mirror, the generator 1 remaining in a fixed position (this variant is not illustrated).

The positioning station PP co-operates with a set of support modules MS. These support modules each comprise a body 3 accommodating a receiving support 4 controlled by a jack 5 associated with the body 3. The receiving support 4 is displaceable vertically or more generally in the direction of the reference line 2, the motion being controlled by the jack 5. Very schematically illustrated, the receiving support 4 comprises a plate 41, the top face of which is provided with several vertical spikes 42. These spikes 42 are fixed relative to the plate 41.

The support modules MS circulate on the circulation route C-MS through a part of the installation; they may be part of a drum or a conveyor chain.

The installation operates in such a way that the support modules MS can either be halted in the loading position in the loading station or can circulate in it if the installation is operating partially or globally on the principle of continuous automation.

In either case, as illustrated in FIG. 2A, the support module MS arriving at the positioning station PP encounters a reference line 2 at a certain instant, formed by the beam generator 1. This reference line 2 is oriented in a precise manner relative to the receiving support 4 so that it serves as a reference for the operator, who can set the item P in or on the receiving support 4. To this end, he takes the item P, turns it round so that its stalk T is directed upwards and in particular aligns it with the reference line 2. Once this orientation is complete, he pins the bottom of the upturned item in the spikes 42. Taking account of the nature of the item P, the spikes 42 are long enough to hold it so that it remains in a fixed position. The support module MS then conveys the item P into the hooking station PA. The circulation route followed by the support modules C-MS is indicated by a broken line.

The hooking station PA does not have fixing means. The route C-MS followed by the support modules MS and the route C-ET taken by the transfer elements ET pass through it. These routes C-MS/C-ET coincide with one another in the hooking station PA. The transfer elements ET comprise a body housing an actuator 10 and bearing hooks 11 pivoting between an open position and a closed position. They are actuated by a jack 12 or a mechanism of this type, which switches them from one position to the other. The transfer element may incorporate a follower 13 which detects the item P as it arrives, for example when it makes contact with the end of the support for the hooks 11. It then triggers the actuation of the hooks 11, either immediately or on a timed basis, which close round the item P.

In the embodiment illustrated here, the transfer elements ET arrive at the positioning station PP and follow a horizontal path. The same applies to the support modules MS, which follow their route through the hooking station PA.

At the inlet, the motion of the transfer elements ET and support modules MS is synchronised so that the axis of a transfer element ET and that of a support module MS coincide. The support module MS then issues a command to raise the receiving support 4 charged with the item P so that it meets the transfer element ET. The inlet making contact with the item and the body of the transfer element trigger actuation of the hooks 12 of the transfer element. These hooks 12 pivot and are inserted in the item P at the point corresponding to the stalk T (if the item was positioned correctly).

Thus charged with the item P, the transfer element ET continues its transfer route C-ET until it arrives at the stalk-removing station PE. Since the axis of orientation is vertical, as specified at the start of the description, the item P is therefore hooked on the transfer element ET in a suspended position. Once the hooking has been effected, a command is issued to the receiving support 4 so that it releases the item P. It is then lowered back into the support module MS as the latter continues its route, leaving the hooking station PA to return to the inlet of the positioning station PP.

As illustrated in FIG. 2B, the stalk-removing station PE comprises the part of the transfer route C-ET used by the transfer elements ET charged with an item P. It also has a cutting device DC equipped with a blade 21. This device is fixed. It is disposed in the path of the item P suspended from the transfer element ET. The blade 21 is displaceable between a retracted position and a deployed position, engaged in the item P on a level with the surface to be cut in order to remove the stalk T from the useful part PU of the item P. This blade 21 is controlled depending on the position of the transfer element ET charged with the item. The blade 21 may be fixed, with the exception of its releasing and retraction motion but it may also be driven with a vibrating motion in order to facilitate cutting. This blade 21 is guided in an inclined position because the stalk or more generally the part of the stalk T to be removed from the item has a flared, essentially conical shape.

The cutting device DC also has a rotary drive device 22 which controls the transfer element ET in the cutting position, in order to drive it in rotation relative to the blade 21.

It was stated earlier that the cutting device DC was fixed. This immobility is relative. This device DC, or at least its blade 21, is fixed relative to the transfer element ET and effects a relative rotating motion about it in order to cut off the stalk T.

If the cutting device DC is fixed relative to the installation, this assumes that the transfer element ET is halted for the time needed to make the cut at the stalk-removing station PE. However, it would also be conceivable to operate on the basis of continuous automation, in which case the cutting device DC would be synchronised with the motion of the transfer element ET during cutting.

This operation may also be performed by a relative rotation of the cutting device as the transfer element makes the transfer.

After cutting off the stalk T, the useful part PU of the item is detached so that the stalk remains hooked on the hooks 11 of the transfer element ET, which continues on its route C-ET allowing the stalk T to drop into a receptacle, and returns to the inlet of the hooking station PA.

FIG. 2B illustrates an extension of the installation with the cutting station PC downstream of the stalk-removing station PE, as well as a means for transferring the useful part PU of the item once the stalk has been removed, at the cutting station PC.

As mentioned above, this transfer means comprises a set of cutting modules MC circulating between the stalk-removing station PE and the cutting station PC. These cutting modules MC have a body 30 incorporating a cutting support 31, which is displaceable in translation between a lowered position and a raised position, as well as a needle 32 borne by the support 31, which is displaceable between an extracted position in which it is able to anchor itself in the item and a retracted position.

The body 30 has a first jack 33 controlling the motion of the cutting support 31 and a second jack 34 inside the cutting support 31, which controls the displacement of the needle 32.

In fact, in the simplest case, only one needle 32 is provided, and is so preferably in a central position. However, depending on the nature of the items to be secured, it would also be possible to provide two or three needles positioned symmetrically.

The cutting module MC with its cutting support 31 is aligned on the associated transfer element ET at the inlet of the stalk-removing station PE, after which it is then fixed in the item P. To this end, the cutting support MC is guided until it makes contact with the bottom of the item P hooked on the transfer element ET. The needle 32 then pierces the item P from underneath over a sufficient length to hold the item firmly in place without at the same time hampering the task of cutting off the stalk T.

The unit thus formed by the transfer element ET and the cutting module MC on either side of the item P (in a <<diametrically opposed position>>) is then fed through the cutting device 20. At the outlet of this device, the useful part PU of the item is not detached from the stalk but is still held fast by the needle 32. The cutting support 31 is then lowered into the cutting module MC without retracting the needle 32 so that the it continues to hold the useful part PU of the item P. The cutting module MC continues along its route C-MC to arrive at the cutting station PC. This cutting station PC has a blade 40, preferably fixed, occupying a diametric position or, if there are several blades, a position radially offset from the cutting axis of the item P/PU. This blade 40 may be in a fixed position or may accompany the cutting module MC if the latter moves continuously without stopping so as to operate in continuous automation.

Cutting is then performed under the control of the cutting support 31, which raises the part PU and applies it against the blade 40 in order to split it. After this operation, once the item has been split, the cutting module MC conveys the cut item to a packaging station or retracts its needle so that the cut pieces are completely released and then collected in a manner not illustrated in readiness for packaging or processing. Although not illustrated, the blade is displaceable in one embodiment.

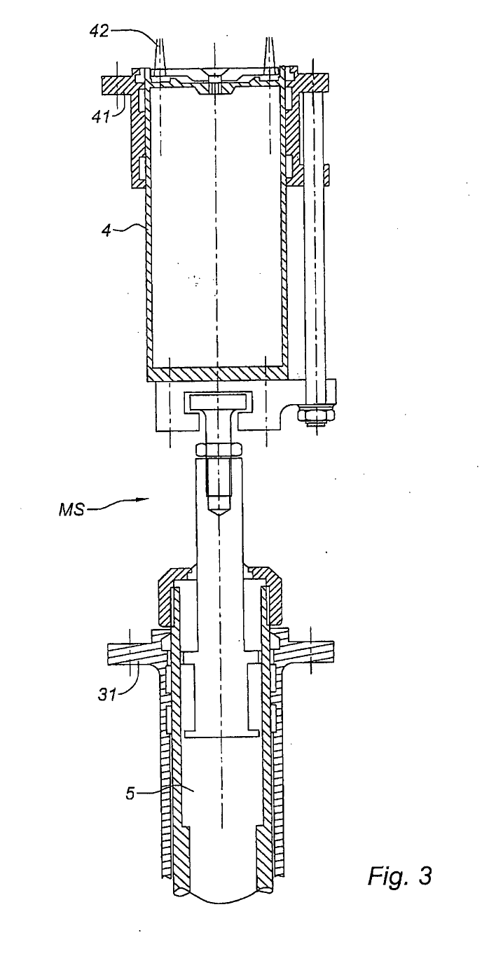

FIG. 3 is a view in section showing the support module MS. This drawing shows not only the module but also the actuator jack 5 housed in the body 3 of the module, its guiding and holding parts 31 being illustrated. The positioning module has a cylindrical part, the bottom of which constitutes the support 41, and has spikes 42 designed to pin the item to be transferred to the hooking station. The positioning support 41 is guided by the means 31 and its deployment and retraction control is controlled by the double-acting jack 5.

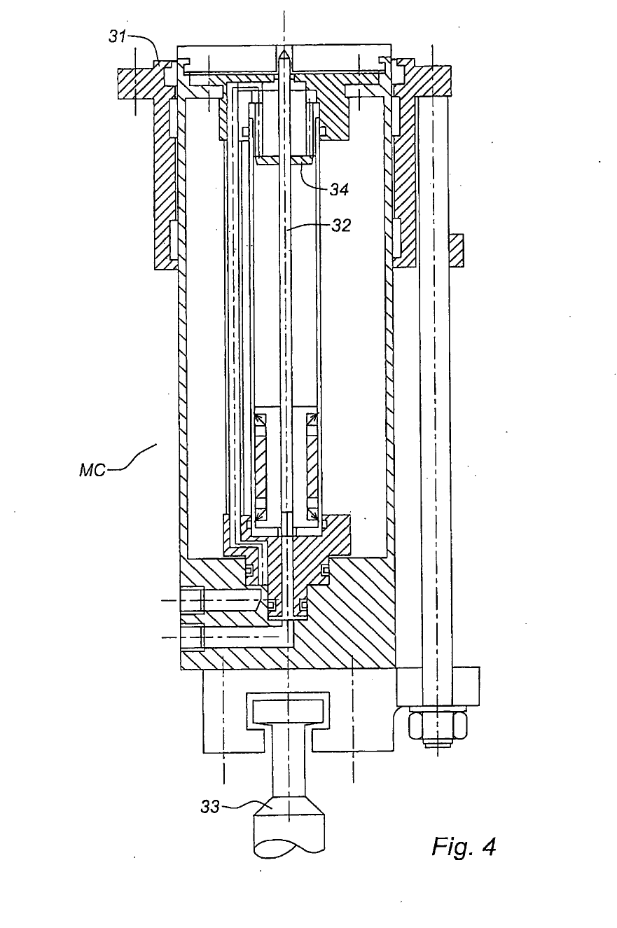

FIG. 4 is a view in section showing a cutting module MC, which is essentially similar or even identical in construction to that of the support module MS except that the cutting support 31 has a needle 32 and a jack 34 for actuating the needle 32 under the conditions explained above. The unit formed by the cutting support MC and the needle 32 is controlled in translation by means of a first jack 33 and the deployment or retraction movement of the needle is controlled by a second jack 34.

1. Method of preparing lettuce heads with means for removing the stalk from the head prior to cutting it, whereby a visible, luminous line is generated on a support module and the item is then positioned on the support and, thus positioned, the item is conveyed to the module where the stalk is removed,
characterised in that
the visible, luminous reference line (2) is generated in the zone where the item (P) is placed on the receiving support (4), this line defining the orientation of the item (P), after which the item is positioned on the support (4) by fixing it and, thus positioned, it is conveyed with the support (4) until it makes contact with a hooking means (ET) so that the item (P) can be automatically picked up and hooked with a view to conveying it in readiness for removing the stalk.

2. Installation for preparing lettuce heads having means for removing the stalk from the head prior to cutting it, comprising
a station for positioning the items,
a stalk-removing station in which the stalk is removed from the items,
a set of modules for receiving the items and conveying them, these modules (MS) circulating along a positioning route passing through the positioning station,
characterised in that
a set of support modules (MS), each having a receiving and anchoring support (4), receives and anchors the items and conveys them, these modules (MS) circulating on a positioning route (C-MS) passing through the positioning station (PP),
the positioning station (PP) has a generator (1) which generates a luminous reference line (2) in a defined position relative to the support module (MS) as it arrives at the positioning station in order to define the position in which the item (P) is placed relative to the receiving support (4),
a hooking station (PA) picks up the items (P) positioned in the receiving supports (4) to convey them in a suspended position and
the stalk-removing station (PE) removes the stalk (T) from the item in the suspended position,
a set of transfer elements (ET) equipped with hooking elements (11) which are anchored in the item (P) on a level with the stalk (T) circulates on a transfer route (C-ET) which rejoins the positioning route (C-MS) and passes through the hooking station (PA) and the stalk-removing station (PE),
the hooking station (PA) receiving the oriented items (P), borne by the support modules (MS),
the stalk-removing station (PE) having a cutting device (DC) equipped with a blade (21) which successively receives the transfer elements (ET) in order to remove the stalk from the items (P), the cut stalk of which remains hooked on the transfer elements (ET).

3. Installation as claimed in claim 2,
characterised in that
it additionally comprises a cutting station (PC) downstream of the stalk-removing station (PE), this station being equipped with a blade (40) for splitting the item (PU) from which the stalk has been removed into several parts and a set of cutting modules (MC) circulating on a cutting route (C-MC) passing through the stalk-removing station (PE) and joining the transfer route (C-ET) in order to secure each module (MC) to an item (P) hooked to a transfer element (ET) and feed the set (MC/P/ET) through the stalk-removing device (ET), which cuts off the stalk (T) hooked to the transfer element (ET) to separate it from the useful part (PU) of the item (P), which remains fixed to its cutting module (MC) so as to be conveyed to the cutting station (PC).

4. Installation as claimed in claim 2,
characterised in that
the support module (MS) comprises a body (3) with a receiving support (4, 41) fitted with spikes (42) on which an item (P) is pinned in order to position it,
this support (4) being displaceable in vertical translation relative to the body (3), controlled by an actuator (5) depending on the position of the module (MS) along its route (C-MS),
in order to position the item (P) in the positioning station (PP) in the bottom position and
in order to guide the item (P) underneath a transfer element (ET) in the hooking station (PA) in the top position.

5. Installation as claimed in claim 2,
characterised in that
the beam generator (1) directs its beam constituting the luminous reference line (2) onto the support module (MS) as it arrives at the positioning station (PP) so as to follow it as the item (P) is being positioned.

6. Installation as claimed in claim 2,
characterised in that
the transfer element (ET) has actuated hooks (11) which anchor themselves in the stalk (T) of the item (P), leaving the contour free to allow a passage for the stalk-removing blade (21).

7. Installation as claimed in claim 2,
characterised in that
the stalk-removing station (PE) comprises
a cutting device (DC) equipped with a blade (21), displaceable between a retracted position and a cutting position sunk in the item from which the stalk is to be removed,
a device (22) for driving the transfer element (ET) in rotation in the cutting position.

8. Installation as claimed in claim 7,
characterised in that
the blade (21) effects a vibrating motion during cutting.

9. Installation as claimed in claim 3,
characterised in that
the cutting module (MC) comprises a body (30) accommodating
a cutting support (31) which is displaceable in translation between a lowered position and a raised position,
a needle (32) borne by the support (31), which is displaceable between an extracted position in which it is anchored in the item (P) and a retracted position,
a first and a second jack (33, 34) respectively controlling the displacement of the support (31) relative to the body (30) and that of the needle (32).

10. Installation as claimed in claim 3,
characterised in that
the blade (40) of the cutting station (PC) is fixed, offset from the path of the needle (32) of the cutting module (MC).

11. Installation as claimed in claim 3,
characterised in that
the blade of the cutting station (PC) is displaceable, offset from the needle (32) of the cutting module (MC).
